(19) United States
(12) Patent Application Publication
(10) Pub. No.: US 2019/0285590 A1
(43) Pub. Date: Sep. 19, 2019

(54) DETECTION SYSTEM, WHEEL, AND DETECTION METHOD

(71) Applicant: KABUSHIKI KAISHA TOSHIBA, Tokyo (JP)

(72) Inventors: Junko HIROKAWA, Shinjuku Tokyo (JP); Ena ISHII, Yokohama Kanagawa (JP); Yasutaka ITO, Kawasaki Kanagawa (JP); Yuki UEDA, Yokohama Kanagawa (JP); Takashi USUI, Saitama Saitama (JP); Takahiro OMORI, Kawasaki Kanagawa (JP); Kazuo WATABE, Yokohama Kanagawa (JP)

(73) Assignee: KABUSHIKI KAISHA TOSHIBA, Tokyo (JP)

(21) Appl. No.: 16/117,710

(22) Filed: Aug. 30, 2018

(30) Foreign Application Priority Data
Mar. 14, 2018 (JP) 2018-046873

(51) Int. Cl. G01N 29/14; G01N 29/36

(52) U.S. Cl. CPC G01N 29/14; G01B 11/26; G01N 2291/0234; G01N 29/36

(57) ABSTRACT

According to an embodiment, a detection system includes a wheel, at least one sensor, a generation unit, and a diagnosis unit. The wheel has an outer edge including an inner wall in which an installation surface is provided. The at least one sensor is installed on the installation surface to detect an elastic wave transmitted from at least one of the wheel and a structure making contact with the wheel. The generation unit is configured to generate time information representing time at which the elastic wave is detected, and feature information representing features of the elastic wave. The diagnosis unit is configured to diagnose, on the basis of the time information and the feature information, a position of a damaged portion of at least one of the wheel and the structure, and a degree of damage of the damaged portion.

### CROSS-REFERENCE TO RELATED APPLICATIONS

This application is based upon and claims the benefit of priority from Japanese Patent Application No. 2018-046873, filed on Mar. 14, 2018; the entire contents of which are incorporated herein by reference.

### FIELD

Embodiments described herein relate generally to a detection system, a wheel, and a detection method.

### BACKGROUND

Machines having rotation mechanisms using a wheel, and structures using the machines have been widely used. For example, railroad vehicles moving on rails, cable cars pulled by cables, cranes and hoists suspending cables therefrom are widely used. To soundly use the machines and the structures, checking (inspection) is indispensable, but the checking requires great efforts. For example, a larger rotation mechanism has a larger weight and a longer rail or cable, and requires greater efforts to check. Furthermore, for example, if too much time is required to check a machine, the machine cannot be operated during checking, and a loss may be generated.

However, while the machine having the rotation mechanism is used, it is difficult to check the conditions of a wheel of the rotation mechanism and a structure making contact with the wheel.

### BRIEF DESCRIPTION OF THE DRAWINGS

FIG. 1 is an exemplary schematic diagram illustrating a wheel according to a first embodiment and a structure making contact with the wheel;

FIG. 2 is a schematic diagram illustrating a vertical cross-section of the wheel of FIG. 1;

FIG. 3A-1 is an enlarged schematic, cross-sectional view illustrating an installation example 1 of an AE sensor according to the first embodiment;

FIG. 3A-2 is an enlarged schematic, cross-sectional view illustrating an installation example 2 of an AE sensor according to the first embodiment;

FIG. 3B is an enlarged schematic, cross-sectional view illustrating an installation example 3 of an AE sensor according to the first embodiment;

FIG. 3C is an enlarged schematic, cross-sectional view illustrating an installation example 4 of an AE sensor according to the first embodiment;

FIG. 4 is a diagram illustrating an exemplary functional configuration of a detection system according to the first embodiment;

FIG. 5 is an exemplary diagram illustrating a method of identifying a position of a source of an elastic wave according to the first embodiment;

FIG. 6 is a diagram illustrating exemplary arrangement of AE sensors according to a modification of the first embodiment;

FIG. 7A is an exemplary schematic diagram illustrating the front side of a wheel according to a second embodiment;

FIG. 7B is an exemplary schematic diagram illustrating a vertical cross-section of the wheel according to the second embodiment;

FIG. 7C is an exemplary schematic diagram illustrating a vertical cross-section of the wheel according to the second embodiment;

FIG. 8 is an exemplary schematic diagram illustrating a cross-section of a wheel according to a third embodiment;

FIG. 9 is a diagram illustrating an example of a hardware configuration of a sensor module according to the first to third embodiments; and

FIG. 10 is a diagram illustrating an example of a hardware configuration of a server device according to the first to third embodiments.

### DETAILED DESCRIPTION

According to an embodiment, a detection system includes a wheel, at least one sensor, a generation unit, and a diagnosis unit. The wheel has an outer edge including an inner wall in which an installation surface is provided. The at least one sensor is installed on the installation surface to detect an elastic wave transmitted from at least one of the wheel and a structure making contact with the wheel. The generation unit is configured to generate time information representing time at which the elastic wave is detected, and feature information representing features of the elastic wave. The diagnosis unit is configured to diagnose, on the basis of the time information and the feature information, a position of a damaged portion of at least one of the wheel and the structure, and a degree of damage of the damaged portion.

Hereinafter, embodiments of a detection system, a wheel, and a detection method will be described in detail with reference to the accompanying drawings.

### First Embodiment

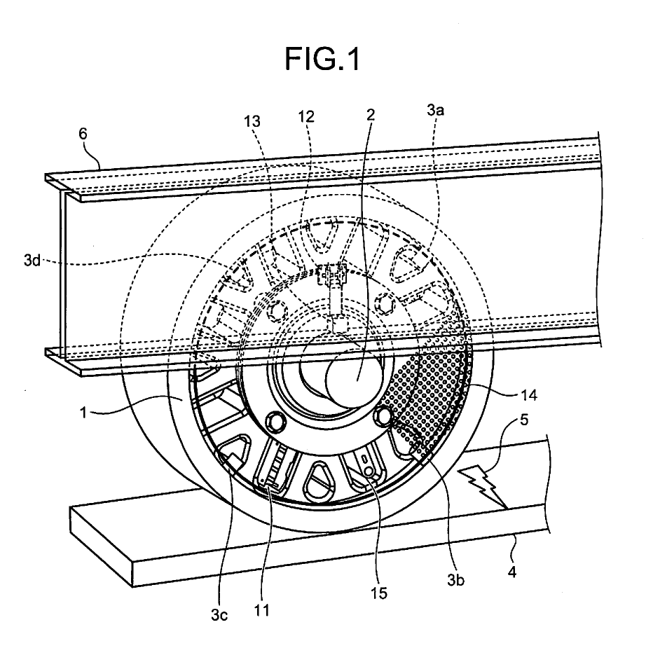

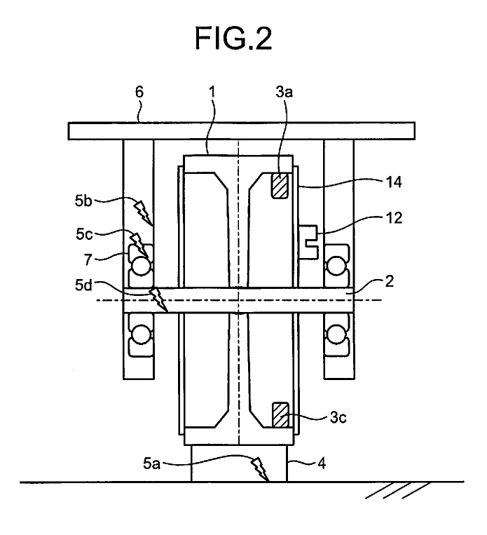

FIG. 1 is an exemplary schematic diagram illustrating a wheel 1 according to a first embodiment and a structure making contact with the wheel 1. FIG. 2 is a schematic diagram illustrating a vertical cross-section of the wheel 1 of FIG. 1. The example of FIG. 1 illustrates the wheel 1 used as a wheel of a vehicle running on a rail 4. In FIG. 1, as an example of the structure making contact with the wheel 1, a chassis 6 of the vehicle and the rail 4 are shown. In FIG. 1, a bearing of a rotation shaft 2 of the wheel 1 is omitted.

In FIG. 1, four acoustic emission (AE) sensors 3a, 3b, 3c, and 3d are arranged on an inner wall of an outer edge of the wheel 1 so that a detection surface of each AE sensor is mounted on the wheel 1 toward an outer periphery. In the example of FIG. 1, the AE sensors 3 are arranged, for example, at certain intervals.

Hereinafter, the AE sensors 3a, 3b, 3c, and 3d not distinctively used are merely referred to as AE sensor 3. The AE sensor 3 detects an elastic wave (AE wave), and converts the elastic wave to a detection signal, such as a voltage signal. Note that any number of AE sensors 3 may be used. At least one AE sensor 3 is desirably used, but a larger number of AE sensors 3 are capable of improving accuracy in diagnosis of a position of a damaged portion 5.

Elastic waves are generated with the progress of deterioration within a material, and are detected before destruction, as a sign of destruction. Furthermore, when members are brought into close contact with each other, the elastic wave propagates in the members without considerable attenuation. Therefore, the AE sensor 3 is also capable of detecting an elastic wave propagating from the rotation shaft 2, the rail 4, and the like which make contact with the wheel 1, through the wheel 1.

The AE sensor 3 is connected to a sensor module (sensor unit) 11 stored in the wheel 1. To the sensor module 11, power is supplied from a power supply unit 15 installed in the wheel 1. For the power supply unit 15, for example, energy harvesting can be used in addition to a battery. The energy harvesting includes, for example, vibration power generation and solar power generation. The sensor module 11 stored in the wheel 1 enables inspection monitoring while rotationally driving the wheel 1, without providing external wiring, a slip ring, and the like.

When the wheel 1 rotates and moves on the rail 4, an elastic wave generated from an AE source being the damaged portion 5 located on the rail 4 is transmitted to the wheel 1. This elastic wave is detected by the AE sensor 3 installed on an inner wall surface of the wheel 1. The damaged portion 5 is, for example, a crack in the rail 4.

A drop prevention cover 14 is mounted in parallel with a rotation surface of the wheel 1 to cover a side surface of the wheel 1. The drop prevention cover 14 prevents drop of the AE sensor 3, the sensor module 11, or the like incorporated in the wheel 1. The drop prevention cover 14 is formed from a radio-transparent member, such as aluminum, resin, perforated metal sheet, not blocking wireless communication of the sensor module 11.

On the drop prevention cover 14 mounted on the side surface of the wheel 1, a rotation detection sensor 12 is installed at a position where the rotation detection sensor 12 does not interfere with the chassis 6. The rotation detection sensor 12 detects the rotation rate of the wheel 1. The rotation detection sensor 12 includes, for example, a photoelectric sensor. The rotation detection sensor 12 is electrically connected to the sensor module 11. The rotation detection sensor 12 detects the rotation rate of the wheel 1 through a light shielding plate 13 fixed in the chassis 6. For the rotation rate, one rotation is detected as one count. Note that, as the rotation detection sensor 12, a magnetic encoder, an optical encoder, a resolver, and the like may be used.

Next, an example of positions of the AE sensors 3 installed and positions of the damaged portions 5 detected by the AE sensors 3 will be described with reference to FIG. 2. The AE sensors 3 are installed on an inner wall of an outer edge of the wheel 1 so that a detection surface of each AE sensor 3 faces toward an outer periphery of the wheel. Therefore, when the wheel 1 is rotated, a centrifugal force pressing the AE sensor 3 toward the outer periphery of the wheel 1, in addition to a force fixing the AE sensor 3, is applied to the detection surface of the AE sensor 3. Note that when the AE sensor 3 is installed perpendicular to a rotation surface of the wheel 1, a force toward the outer periphery is applied to the main body of the AE sensor 3, as a force shearing a main body of the AE sensor 3, due to the centrifugal force, and the life of the AE sensor 3 is likely to be reduced.

The AE sensor 3 detects a damaged portion 5a on the rail with 4 which the wheel 1 makes contact, a damaged portion 5b on the chassis 6 for holding the wheel 1, a damaged portion 5c on a bearing 7, and a damaged portion 5d on the rotation shaft 2.

### INSTALLATION EXAMPLE

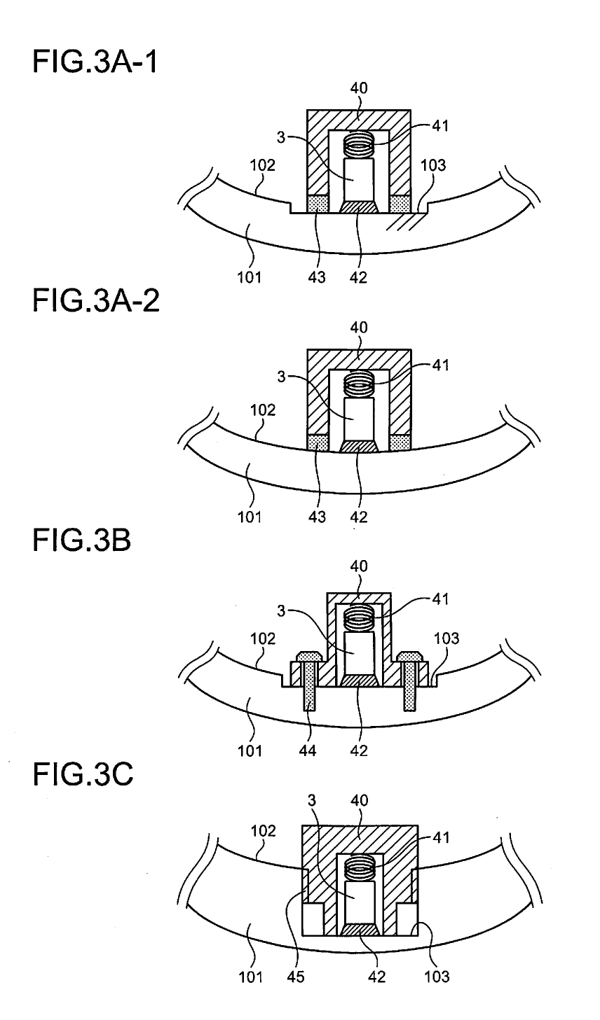

FIG. 3A-1 is an enlarged schematic, cross-sectional view illustrating an installation example 1 of the AE sensor 3 according to the first embodiment. FIG. 3A-1 illustrates an example of installation of the AE sensor 3 on an installation surface 103 formed in an inner wall surface 102 of an outer edge 101 of the wheel 1. The installation surface 103 of the AE sensor 3 desirably has a flat surface without roughness. However, the inner wall surface 102 extending along the outer edge 101 of the wheel 1 has a curvature and has no flatness. Therefore, in the wheel 1, the installation surface 103 being flat is provided so that the detection surface of the AE sensor 3 faces toward the outer periphery of the wheel 1. In the example of FIG. 3A-1, the installation surface 103 is a flat surface formed perpendicular to a direction of a centrifugal force generated by the rotation of the wheel 1. The installation surface 103 having a flatness is formed in an inner wall of the outer edge 101 of the wheel 1 by, for example, being cut with a milling cutter or the like.

A casing 40 internally stores the AE sensor 3. The casing 40 includes a magnet portion 43 and magnetically fixed to the wheel 1 including iron. The AE sensor 3 is fixed to the installation surface 103 by a spring 41 provided in the casing 40. At this time, the spring 41 applies, to the installation surface 103, a force expressed by F1=kx (k: a constant of the spring 41, x: shrinkage of the spring 41), and a force expressed by F2=m(v²/r) (m: a weight of the wheel 1, v: a rotation speed of the wheel 1, r: a distance between the installation surface 103 and the center of the wheel 1). The force expressed by F2=m(v²/r) is generated by a centrifugal force due to the rotation of the wheel 1. That is, the centrifugal force F2 generated by the rotation movement can be used to fix the AE sensor 3. The detection surface of the AE sensor 3 includes a piezoelectric element, and is protected with silicone grease 42 or the like. Since the silicone grease 42 serves as an acoustic couplant, the AE sensor 3 efficiently detects an elastic wave. Note that as in an installation example 2 illustrated in FIG. 3A-2, when the AE sensor 3 has a cross-section of a size (horizontal width size of the cross-section in FIG. 3A-2) sufficiently small relative to a curvature radius of the wheel 1, and the elastic wave is substantially uniformly transmitted between the wheel 1 and the AE sensor 3 through the silicone grease 42 or the like, the installation surface 103 having a flatness does not need to be formed by cutting. In this configuration, the inner wall surface 102 of the wheel 1 serves as the installation surface 103. In this configuration, a contact surface of the magnet portion 43 making contact with the wheel 1 is preferably shaped in conformance with the inner wall of the wheel 1.

FIG. 3B is an enlarged schematic, cross-sectional view illustrating an installation example 3 of the AE sensor 3 according to the first embodiment. The example of FIG. 3B illustrates the AE sensor 3 fixed, with screws, on the installation surface 103 formed in the inner wall surface 102 of the wheel 1. The casing 40 includes mounting holes for inserting bolts 44 therethrough. The casing 40 is fixed at screw holes provided in the outer edge 101 of the wheel 1 with the bolts 44.

FIG. 3C is an enlarged schematic, cross-sectional view illustrating an installation example 4 of the AE sensor 3 according to the first embodiment. In the example of FIG. 3C, the casing 40 includes a threaded portion 45, and is screwed into a screw hole tapped in the inner wall 102 of the outer edge 101 of the wheel 1. The detection surface of the AE sensor 3 is pressed against the installation surface 103 by the spring 41 provided in the casing 40. Since the installation surface 103 faces toward the outer periphery, when the wheel 1 rotates, a centrifugal force caused by the rotation acts in a direction, which the AE sensor 3 is pressed. Therefore, the AE sensor 3 can be fixed on the installation surface 103 with less force.

### Example of Functional Configuration

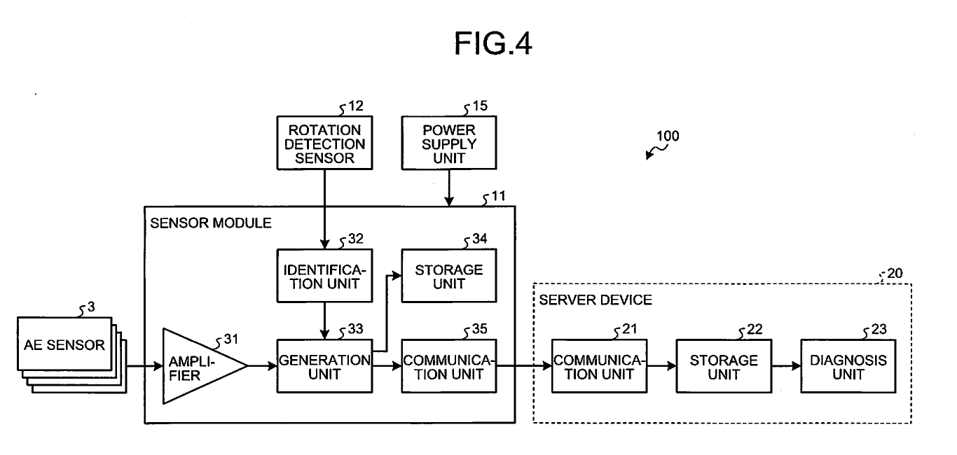

FIG. 4 is a diagram illustrating an exemplary functional configuration of a detection system 100 according to the first embodiment. The detection system 100 according to the first embodiment includes the AE sensor 3, the sensor module 11, the rotation detection sensor 12, the power supply unit 15, and a server device 20. The sensor module 11 includes an amplifier 31, an identification unit 32, a generation unit 33, a storage unit 34, and a communication unit 35. The server device 20 includes a communication unit 21, a storage unit 22, and a diagnosis unit 23.

When detecting an elastic wave through the wheel 1, the AE sensor 3 converts the elastic wave to a detection signal, such as a voltage signal. The AE sensor 3 inputs the detection signal to the sensor module 11.

When receiving a detection signal from the AE sensor 3, the amplifier 31 of the sensor module 11 amplifies the detection signal. Note that when an amplifier is incorporated in the AE sensor 3, the process of the amplifier 31 may be omitted.

When detecting the rotation rate of the wheel 1, the rotation detection sensor 12 inputs rotation-rate information representing the rotation rate to the sensor module 11.

When receiving the rotation-rate information from the rotation detection sensor 12, the identification unit 32 of the sensor module 11 identifies a turning angle of the wheel 1 and time at which the wheel 1 is positioned at the turning angle, from the rotation-rate information. The identification unit 32 inputs turning angle information and time information to the generation unit 33. The turning angle information represents the turning angle, and the time information represents the time at which the wheel 1 is positioned at the turning angle.

When receiving an amplified detection signal from the amplifier 31, the generation unit 33 converts the data format of the detection signal from an analog format to a digital format. When the detection signal having a data format converted to the digital format has a value equal to or more than a detection threshold value, the generation unit 33 generates time information and feature information. The time information represents time at which the detection signal is detected, and the feature information represents the features of the detection signal. The generation unit 33 stores the feature information and the time information in the storage unit 34.

The feature information includes, for example, the amplitude [mV] of a waveform of a detection signal, the duration [usec] of the waveform of the detection signal, the zero crossing counts [times] of the detection signal, the energy [arb.] of the waveform of the detection signal, and the frequency [Hz] of the detection signal.

Furthermore, when receiving the turning angle information and the time information from the identification unit 32, the generation unit 33 stores, in the storage unit 34, the time information on the same time axis as the time information representing time at which the detection signal is detected, associating the feature information stored in the storage unit 34 with the turning angle information. Then, the generation unit 33 inputs the feature information, the turning angle information, and the time information to the communication unit 35.

When receiving the feature information, the turning angle information, and the time information from the generation unit 33, the communication unit 35 transmits the feature information, the turning angle information, and the time information to the server device 20.

When receiving the feature information, the turning angle information, and the time information from the sensor module 11, the communication unit 21 of the server device 20 stores the feature information, the turning angle information, and the time information in the storage unit 22.

The diagnosis unit 23 reads the feature information, the turning angle information, and the time information from the storage unit 22, uses the feature information, the turning angle information, and the time information to diagnose a position of the damaged portion 5 in at least one of the wheel 1 and the structure making contact with the wheel 1 and a degree of damage of the damaged portion 5. The degree of damage of the damaged portion 5 can be diagnosed, for example, on the basis of the feature information described above.

At least one AE sensor 3 is desirably arranged in the wheel 1, but when two or more AE sensors 3 are arranged on the wheel 1, the position of the damaged portion 5 can be highly accurately identified on the basis of a difference in the feature information and the turning angle information. Accuracy in identification of the damaged portion 5 can be increased with increasing number of the AE sensors 3.

Note that the configuration of the detection system 100 illustrated in FIG. 4 is provided by way of example, and can be appropriately modified and changed. For example, the diagnosis unit 23 may be included in the sensor module 11.

### Example of Identification Method

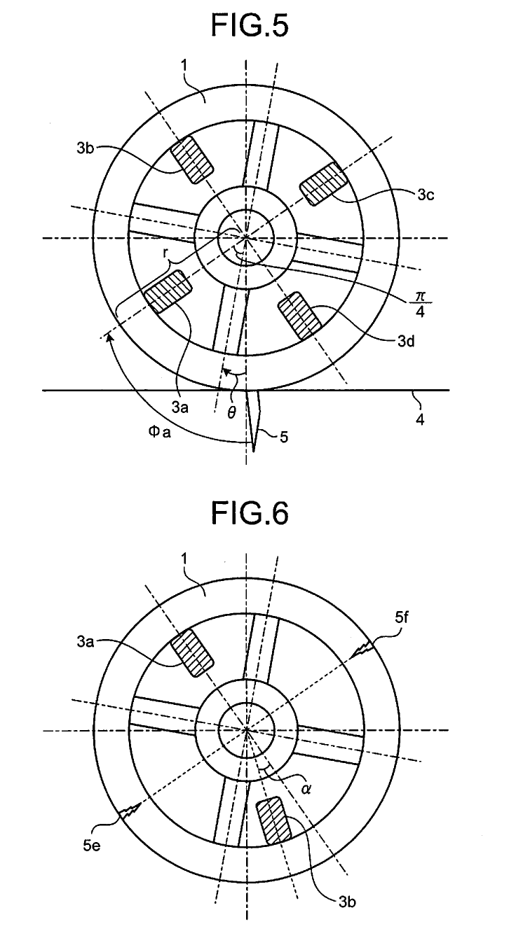

FIG. 5 is an exemplary diagram illustrating a method of identifying a position of a source of an elastic wave according to the first embodiment. FIG. 5 is an exemplary schematic diagram illustrating the front side of the wheel 1 running on the rail 4 having the damaged portion 5. In the example of FIG. 5, the AE sensors 3a to 3d are uniformly arranged in the wheel 1 with a phase difference of π/2. Therefore, even though the wheel 1 rotates, at least two of the AE sensors 3a to 3d can be positioned near the rail 4.

It is assumed that when the wheel 1 passes over the damaged portion 5, the wheel 1 is positioned at a turning angle θ. At this time, turning angles ϕa to ϕd indicating the positions of the AE sensors 3a to 3d are expressed by the following formulas (1) to (4).

ϕa=(θ+π/4) (1)

ϕb=(θ+3π/4) (2)

ϕc=(θ+5π/4)=(3π/4−θ) (3)

ϕd=(θ+7π/4)=(π/4−θ) (4)

An elastic wave generated from the damaged portion 5 is transmitted to the AE sensors 3a to 3d through the outer periphery of the wheel 1. When the wheel 1 has a radius r, distances Sa to Sd from the damaged portion 5 to the AE sensors 3a to 3d are expressed by the following formulas (5) to (8).

Sa=r×ϕa=r(θ+π/4) (5)

Sb=r×ϕb=r(θ+3π/4) (6)

Sc=r×ϕc=r(3π/4−θ) (7)

Sd=r×ϕd=r(π/4−θ) (8)

Furthermore, in the example of FIG. 5, when time at which the AE sensor 3d nearest to the damaged portion 5 detects the elastic wave is t, and a transmission speed of the elastic wave is v [m/s], the distances Sa to Sd are expressed by the following formulas (9) to (12).

Sa=v(t+Δt1) (9)

Sb=v(t+Δt3) (10)

Sc=v(t+Δt2) (11)

Sd=vt (12)

Here, Δt1 to Δt3 (Δt1<Δt2<Δt3) each indicate a difference in arrival time of the elastic wave. The positions of the AE sensors 3a to 3d vary according to the turning angle of the wheel 1. Since the AE sensors 3a to 3d are installed at different positions on the inner wall 102 of the outer edge 101 of the wheel 1, when the AE sensors 3a to 3d detect the elastic wave from an outer peripheral portion of the wheel 1, there is a difference in time at which the elastic wave reaches the respective AE sensors 3a to 3d. Meanwhile, the nearer the source of the elastic wave is to a rotation center of the wheel 1, the less a difference Δt in arrival time of the elastic wave to each of the AE sensors 3a to 3d is, regardless of the turning angle of the wheel 1. Thus, the diagnosis unit 23 is capable of diagnosing the source of the elastic wave (the position of the damaged portion 5) on the basis of the presence/absence of a difference Δt in arrival time.

Note that when the turning angle information cannot be obtained due to breakage or non-installation of the rotation detection sensor 12, the position of the AE sensor 3 varying according to the turning angle of the wheel 1 cannot be identified. In this case, accuracy in identification of the source (the position of the damaged portion 5) of the elastic wave reaching through the outer edge 101 of the wheel 1 is reduced relative to accuracy in identification of the source when the position of the AE sensor 3 can be identified. Note that even though the turning angle information cannot be obtained, when the elastic wave has a small difference Δt in arrival time (e.g., smaller than a position determination threshold value), the diagnosis unit 23 is capable of diagnosing that the source of the elastic wave is in the wheel 1 (e.g., near the rotation center).

As described above, in the detection system 100 according to the first embodiment, the wheel 1 includes the installation surface 103 in the inner wall 102 of the outer edge 101. At least one sensor (AE sensor 3) is installed on the installation surface 103, and detects an elastic wave from at least one of the wheel 1 and the structure making contact with the wheel 1. The generation unit 33 generates time information representing time at which the elastic wave is detected and feature information representing the features of the elastic wave. Then, on the basis of the time information and the feature information, the diagnosis unit 23 diagnoses the position of the damaged portion 5 in at least one of the wheel 1 and the structure making contact with the wheel 1 and a degree of damage of the damaged portion 5.

Therefore, even though a machine having a rotation mechanism is being used, the detection system 100 according to the first embodiment enables inspection of the conditions of the wheel 1 of the rotation mechanism and a structure making contact with the wheel 1.

### Modification of First Embodiment

Next, a modification of the first embodiment will be described. In the description of the modifications of the first embodiment, a description similar to that of the first embodiment will be omitted, and a description of a difference from that of the first embodiment will be made.

FIG. 6 is a diagram illustrating exemplary arrangement of the AE sensors 3 according to a modification of the first embodiment. In the example of FIG. 6, two AE sensors 3a and 3b are arranged in the wheel 1. The two AE sensors 3a and 3b are installed so that a phase difference between a turning angle representing an installation position of the AE sensor 3a and a turning angle representing an installation position of the AE sensor 3b is π+α (0<α<π/4). Therefore, for example, when the positions of damaged portions 5e and 5f are sources of elastic waves, either AE sensor 3a or AE sensor 3b is positioned nearer to one of the sources. Thus, the diagnosis unit 23 is capable of identifying the positions of the damaged portions 5e and 5f by using the identification method described above with reference to FIG. 5.

### Second Embodiment

Next, a second embodiment will be described. In the description of the second embodiment, a description similar to that of the first embodiment will be omitted, and a description of a difference from that of the first embodiment will be made.

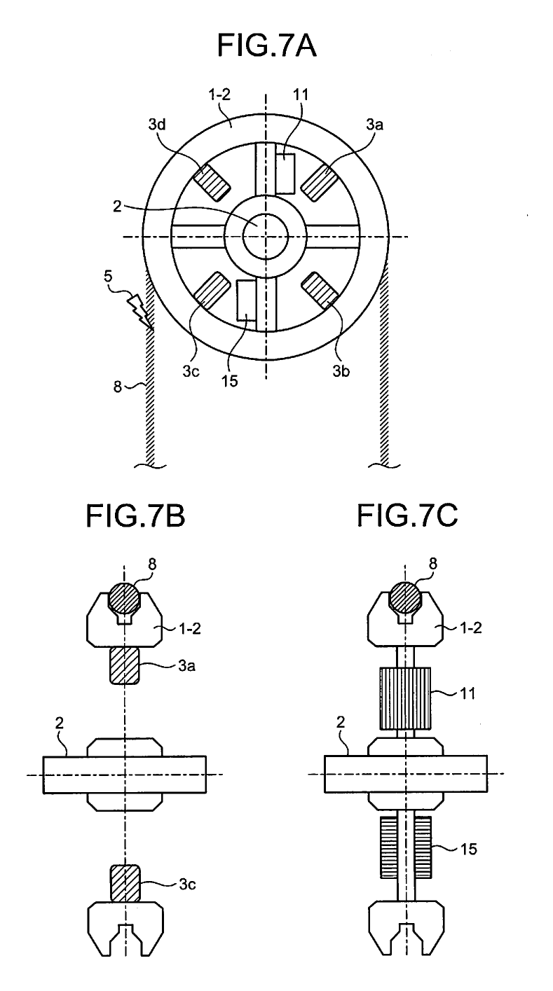

FIG. 7A is an exemplary schematic diagram illustrating the front side of a wheel 1-2 according to a second embodiment. The example of FIG. 7A illustrates an embodiment of the wheel 1-2 of a pulley operated by transmitting power to a rope. The wheel 1-2 has a groove on an outer periphery and incorporates a bearing. The wheel 1-2 has a fixed rotation shaft 2, and one or a plurality of ropes 8 having a load at an end are wound around the wheel 1-2.

The AE sensors 3a to 3d are installed on an inner wall of the wheel 1-2 so that an installation surface of each AE sensor faces toward an outer periphery. The AE sensors 3a to 3d detect an elastic wave generated from the wheel 1-2, the rope 8 making contact with the wheel 1-2, the rotation shaft 2, and the like, as a sign of breakage of each component. The AE sensors 3a to 3d are connected to the sensor module 11 fixed in the wheel 1-2.

To the sensor module 11, power is supplied from the power supply unit 15 incorporated in the wheel 1-2. For the power supply unit 15, an energy harvester, such as a solar power generation module and a vibration power generation module, can be used in addition to a battery.

FIG. 7B is an exemplary schematic diagram illustrating a vertical cross-section taken along a line passing through the center of the wheel 1-2 and the AE sensors 3a and 3c according to the second embodiment. As illustrated in FIG. 7B, since the AE sensor 3 is centered in the width of the wheel 1-2, an elastic wave transmitted through the wheel 1-2 can be efficiently detected, and the wheel 1-2 can be turned with less deviation of the center of gravity during operation.

FIG. 7C is an exemplary schematic diagram illustrating a vertical cross-section of the wheel 1-2 according to the second embodiment. FIG. 7C illustrates an example of installation of the sensor module 11 and the power supply unit 15. As illustrated in FIG. 7C, since the sensor module 11 and the power supply unit 15 are accommodated in the wheel 1-2, the sensor module 11 and the power supply unit 15 can be operated without interference with the outside of the wheel 1.

### Third Embodiment

Next, a third embodiment will be described. In the description of the third embodiment, a description similar to that of the first embodiment will be omitted, and a description of a difference from that of the first embodiment will be made.

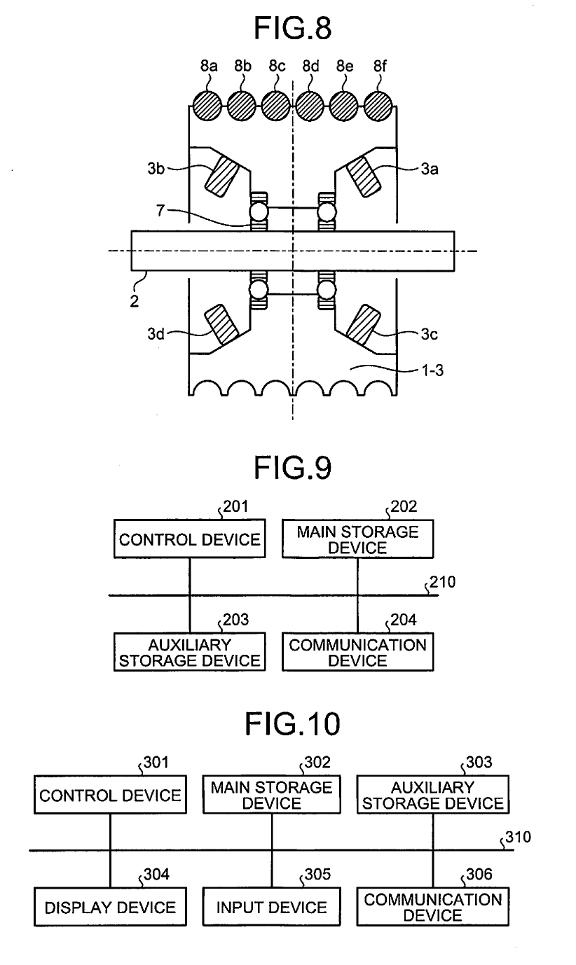

FIG. 8 is an exemplary schematic diagram illustrating a cross-section of a wheel 1-3 according to the third embodiment. The example of FIG. 8 illustrates an installation example of the AE sensors 3 when a plurality of ropes 8 is wound around the wheel 1-3 of a pulley. The AE sensors 3 are installed on inclined surfaces of the inner wall of the wheel 1-3 so that an installation surface of each AE sensor 3 faces toward an outer periphery. Each inclined surface desirably has an angle within 45° so that a centrifugal force is not cancelled by the gravity. Even though the AE sensors 3 are installed on one side surface of the wheel 1-3, a difference between amplitudes of an elastic wave enables location (diagnosis) of a damaged portion 5. Furthermore, in the wheel 1-3, since the AE sensors 3 are installed on both side surfaces of a rotation surface, a source of an elastic wave (AE source) from the ropes 8a to 8f can be identified. Specifically, for example, a phase of an AE source is identified on the basis of an elastic wave detected by a pair of AE sensors 3a and 3c in a side surface, and further a rope 8 having a damaged portion 5 is identified by an elastic wave detected by a pair of opposed AE sensors 3a and 3b.

Finally, an example of a hardware configuration of the sensor module 11 and the server device 20 according to the embodiments and modification will be described.

### Example of Hardware Configuration

FIG. 9 is a diagram illustrating an example of a hardware configuration of the sensor module 11 according to the first to third embodiments. The sensor module 11 according to the first to third embodiments includes a control device 201, a main storage device 202, an auxiliary storage device 203, and a communication device 204. The control device 201, the main storage device 202, the auxiliary storage device 203, and the communication device 204 are connected via a bus 210.

The control device 201 executes a program loaded from the auxiliary storage device 203 into the main storage device 202. The main storage device 202 is a memory, such as a read only memory (ROM) and a random access memory (RAM). The auxiliary storage device 203 is a memory card or the like. The storage unit 34 of FIG. 4 corresponds to the main storage device 202 and the auxiliary storage device 203.

The communication device 204 is an interface for communicating with the server device 20 or the like.

Programs executed by the sensor module 11 according to the first to third embodiments are recorded in a computer-readable storage medium, such as a CD-ROM, a memory card, a CD-R, and a digital versatile disc (DVD), in an installable or executable format, and provided as a computer program product.

Furthermore, the programs executed by the sensor module 11 according to the first to third embodiments may be stored on a computer connected to a network, such as the Internet, and provided by being downloaded via the network.

Furthermore, the programs executed by the sensor module 11 according to the first to third embodiments may be provided via the network, such as the Internet, instead of being downloaded.

Furthermore, the programs executed by the sensor module 11 according to the first to third embodiments may be provided by being previously installed on a ROM or the like.

The programs executed by the sensor module 11 according to the first to third embodiments have a module configuration including functional blocks which are also achieved by the programs, of functional blocks of the sensor module 11 of FIG. 4 described above. As actual hardware, in each functional block, the control device 201 reads a program from the storage medium and executes the program, and each functional block is loaded in the main storage device 202. That is, each of the functional blocks is generated in the main storage device 202.

Note that part or all of the functional blocks of FIG. 4 may be achieved by hardware, such as an integrated circuit (IC), without using software.

Furthermore, when a plurality of processors is used to achieve the respective functions, each of the processors may achieve one of the functions, or two or more of the functions.

FIG. 10 is a diagram illustrating an example of a hardware configuration of the server device 20 according to the first to third embodiments. The server device 20 according to the first to third embodiments includes a control device 301, a main storage device 302, an auxiliary storage device 303, a display device 304, an input device 305, and a communication device 306. The control device 301, the main storage device 302, the auxiliary storage device 303, the display device 304, the input device 305, and the communication device 306 are connected via a bus 310.

The control device 301 executes a program loaded from the auxiliary storage device 303 into the main storage device 302. The main storage device 302 is a memory, such as a ROM and a RAM. The auxiliary storage device 303 is a hard disk drive (HDD), a memory card, or the like. The storage unit 22 of FIG. 4 corresponds to the main storage device 302 and the auxiliary storage device 303.

The display device 304 displays, for example, a state of the server device 20. The display device 304 is, for example, a liquid crystal display. The input device 305 is an interface for operating the server device 20. The input device 305 is, for example, a keyboard, a mouse, or the like. When the server device 20 is a smart device, such as a smartphone and a tablet terminal, the display device 304 and the input device 305 are, for example, a touch panel. The communication device 306 is an interface for communicating with the sensor module 11 or the like.

Programs executed by the server device 20 according to the first to third embodiments are recorded in a computer-readable storage medium, such as a CD-ROM, a memory card, a CD-R, and a DVD, in an installable or executable format, and provided as a computer program product.

Furthermore, the programs executed by the server device 20 according to the first to third embodiments may be stored on a computer connected to a network, such as the Internet, and provided by being downloaded via a network. Furthermore, the programs executed by the server device 20 according to the first to third embodiments may be provided via a network, such as the Internet, instead of being downloaded.

Furthermore, the programs executed by the server device 20 according to the first to third embodiments may be provided by being previously installed on a ROM or the like.

The programs executed by the server device 20 according to the first to third embodiments have a module configuration including functional blocks which are also achieved by the programs, of functional blocks of the server device 20 of FIG. 4 described above. As actual hardware, in each functional block, the control device 301 reads a program from the storage medium and executes the program, and each functional block is loaded in the main storage device 302. That is, each of the functional blocks is generated in the main storage device 302.

Note that part or all of the functional blocks of FIG. 4 may be achieved by hardware, such as an IC, without using the software.

Furthermore, when a plurality of processors is used to achieve the respective functions, each of the processors may achieve one of the functions, or two or more of the functions.

Furthermore, the server device 20 according to the first to third embodiments may have a desirable operation mode. The server device 20 according to the first to third embodiments may be operated, for example, as a cloud system on a network.

For example, the detection system 100 according to the embodiments described above may be applied to detect deterioration of a wheel and wire rope used for an elevator.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A detection system comprising:
a wheel having an outer edge including an inner wall in which an installation surface is provided;
at least one sensor installed on the installation surface to detect an elastic wave transmitted from at least one of the wheel and a structure making contact with the wheel;
a generation unit configured to generate time information representing time at which the elastic wave is detected, and feature information representing features of the elastic wave; and
a diagnosis unit configured to diagnose, on the basis of the time information and the feature information, a position of a damaged portion of at least one of the wheel and the structure, and a degree of damage of the damaged portion.

2. The detection system according to claim 1, further comprising
an acquisition unit configured to acquire a turning angle of the wheel,
wherein the diagnosis unit diagnoses a position of the damaged portion further on the basis of a position of the sensor identified on the basis of the turning angle.

3. The detection system according to claim 2, further comprising
a plurality of sensors,
wherein the diagnosis unit diagnoses a position of the damaged portion, further on the basis of a difference in the time information of the elastic wave detected by the plurality of sensors.

4. The detection system according to claim 1, further comprising
two sensors,
wherein the two sensors are installed so that a phase difference between a turning angle representing an installation position of one of the sensors and a turning angle representing an installation position of the other of the sensors is π+α (0<α<π/4).

5. The detection system according to claim 1, wherein
the installation surface is a flat surface formed in an inner wall of an outer edge of the wheel.

6. The detection system according to claim 1, wherein
the installation surface is a flat surface formed perpendicular to a direction of a centrifugal force generated by rotation of the wheel.

7. The detection system according to claim 1, further comprising:
a communication unit installed at the wheel to transmit the time information and the feature information by wireless communication; and
a power supply unit installed at the wheel to supply power to the sensor, the generation unit, and the communication unit,
wherein the diagnosis unit diagnoses, on the basis of the time information and the feature information received from the communication unit, a position of a damaged portion of at least one of the wheel and the structure and a degree of damage of the damaged portion.

8. The detection system according to claim 7, wherein
a drop prevention cover formed of a radio-transparent member not blocking wireless communication of the communication unit is installed at the wheel.

9. A wheel comprising:
at least one sensor installed on an installation surface in an inner wall of a wheel outer edge to detect an elastic wave transmitted from at least one of the wheel and a structure making contact with the wheel;
a generation unit configured to generate time information representing time at which the elastic wave is detected, and feature information representing features of the elastic wave;
a communication unit configured to transmit the time information and the feature information by wireless communication; and
a power supply unit configured to supply power to the sensor, the generation unit, and the communication unit.

10. A detection method comprising:
detecting an elastic wave transmitted from at least one of a wheel and a structure making contact with the wheel by at least one sensor installed on an installation surface provided in an inner wall of a wheel outer edge;
generating time information representing time at which the elastic wave is detected and feature information representing features of the elastic wave by a generation unit; and
diagnosing a position of a damaged portion of at least one of the wheel and the structure and a degree of damage of the damaged portion, on the basis of the time information and the feature information, by a diagnosis unit.
